(19) United States
(12) Patent Application Publication
(10) Pub. No.: US 2009/0009495 A1
(43) Pub. Date: Jan. 8, 2009

(54) USB display driver, and small-scale mobile monitor and USB display system having the USB display diriver

(75) Inventors: Byung-chul Jeon, Seongnam-si (KR); Kyung-lip Park, Seongnam-si (KR)

Correspondence Address: MILLS & ONELLO LLP, ELEVEN BEACON STREET, SUITE 605, BOSTON, MA, 02108, US

(73) Assignee: Samsung Electronics CO., Ltd., Suwon-si (KR)

(21) Appl. No.: 12/215,953

(22) Filed: Jul. 1, 2008

(30) Foreign Application Priority Data
Jul. 6, 2007 (KR) 10-2007-0068168

(51) Int. Cl. G09G 5/00

(52) U.S. Cl. 345/204

(57) ABSTRACT

Provided is a universal serial bus (USB) display driver including a USB receiving unit that serially receives an image data signal from a host via a USB interface and extracts display data and control data from the image data signal, and a display driver that generates a display data voltage corresponding to the display data based on the control data and applies the display data voltage to a small-scale mobile panel. The USB receiving unit, the display driver and the small-scale mobile panel operate using power delivered via the USB interface, and a panel size of the small-scale mobile panel is less than or equal to a panel size corresponding to a maximum speed of data transmission of the USB interface.

### CROSS-REFERENCE TO RELATED PATENT APPLICATIONS

This application claims the benefit of priority to Korean Patent Application No. 10-2007-0068168, filed on Jul. 6, 2007, in the Korean Intellectual Property Office, the disclosure of which is incorporated herein in its entirety by reference.

### BACKGROUND OF THE INVENTION

1. Field of the Invention

The present invention relates to a universal serial bus (USB) display driver, and a small-scale mobile monitor and a USB display system having the USB display driver, and more particularly, to a USB display driver capable of performing a display operation according to USB interface specifications.

2. Description of the Related Art

A display monitor installed in a small-scale display device, such as a liquid crystal display (LCD) handheld phone, displays an image corresponding to an image data signal received from a host. The image data signal is transmitted from the host to the display monitor according to a predetermined type of interface. The type of an interface is determined, for example, by a manufacturing company of the LCD handheld phone, or the specifications thereof.

FIG. 1 illustrates an interface between a host 110 and a display monitor 120 in a small-scale display device 100, e.g., a cellular telephone or a personal digital assistant.

An image data signal is transmitted from the host 110 to the display monitor 120 via an interface IF. A display driver 130 that receives the image data signal generates a display data voltage corresponding to the image data signal. A display panel 140 to which the display data voltage is applied displays an image corresponding to the image data signal.

As described above, the type of an interface between the host 110 and the display driver 130 depends on a manufacturing company of or the specifications of the small-scale display device 100. The types of interfaces available to be implemented between the host 110 and the display driver 130 can be categorized as described below.

An red-green-blue (RGB) interface type enables a large amount of data to be rapidly transmitted in real time without using a memory. The RGB interface type is mainly used to display moving pictures. Another type of interface is a a central processing unit (CPU) interface. In the case of the CPU interface type, data received from a host is first stored in a memory, e.g., a graphic random access memory (RAM), and the data is read back from the memory to display an image. A CPU interface type is advantageous in displaying a still image or an image that undergoes few changes. A serial interface type enables data to be transmitted using a small number of interface lines (e.g., pins, ports, or transmission lines). The total number of interface lines used in the serial interface type is less than that used in a parallel interface type, such as the RGB interface type or the CPU interface type. Thus, the speed of data transmission of the serial interface type is slower than that of the parallel interface type. A high-speed serial interface type has been introduced in order to improve the speed of data transmission of the serial interface type. Examples of the high-speed serial interface type include a mobile industry processor interface (MIPI) and a mobile display digital interface (MDDI).

However, since the type of interface available between the host 110 and the display driver 130 is different according to the manufacturing company of or the specifications of the small-scale display device 100, the compatibility of the small-scale display device 100 is low. The lower the compatibility of a product, the longer the time required to develop the product and the greater the manufacturing costs thereof. For the compatibility of the product, a manufacturing company of the display driver 130 must apply a restriction on the product so that the product can properly work with the a specific interface type.

### SUMMARY OF THE INVENTION

In accordance with the present invention, provided is a universal serial bus (USB) display driver that uses USB interface specifications in order to substantially guarantee compatibility.

Also in accordance with the present invention, provided is a small-scale mobile monitor using the USB display driver.

Further in accordance with the present invention, provided is a USB display system using the USB display driver.

According to an aspect of the present invention, there is provided a universal serial bus (USB) display system including: a host configured to serially output an image data signal containing display data and control data by using a USB transmission unit; a USB receiving unit configured to extract the display data and the control data from the image data signal serially received via a USB interface; a display driver configured to generate a display data voltage corresponding to the display data based on the control data; and a small-scale mobile panel configured to receive the display data voltage and to display an image corresponding to the image data signal.

The USB receiving unit, the display driver, and the small-scale mobile panel can operate using power delivered via the USB interface.

A panel size of the small-scale mobile panel can be limited by a maximum speed of data transmission supported by the USB interface.

The panel size of the small-scale mobile panel can be less than or equal to a panel size corresponding to a maximum size of an image that is to be displayed when the USB interface transmits the image data signal at the maximum speed of data transmission.

The small-scale mobile panel can be a display panel included in a handheld-phone, a portable multimedia player (PMP), a personal digital assistant (PDA), a navigation device, or a digital camera.

The USB receiving unit and the display driver can be integrated on one chip.

Also, the USB receiving unit can be integrated on a chip different from a chip on which the display driver is integrated.

The USB receiving unit can include: a physical layer block configured to serially receive the image data signal via the USB interface; a data separating unit configured to separate the image data signal to extract the display data and the control data; a display data output unit configured to output the display data; and a control data output unit configured to output the control data.

The display data output unit can be configured to receive the display data in parallel from the data separating unit, and to output the display data in parallel to the display driver.

The control data output unit can be configured to receive the control data in parallel from the data separating unit, and to outputs the control data in parallel to the display driver.

The display driver can include: a register unit configured to receive the control data and to extract format information and address information from the control data; a pixel format unit configured to format the display data to conform to the format information and then to output the formatted display data; an address generation unit configured to receive the address information and to generate an address signal; and a frame buffer configured to store the formatted display data in an address corresponding to the address signal.

The control data can further include timing information and analog interface information.

The display driver can further include: a timing controller configured to control timing of the display driver to conform to the timing information; and an analog interface unit configured to control an analog interface of the display driver to conform to the analog interface information.

Also, the display driver can further include an analog processor configured to receive the formatted display data from the frame buffer, generate the display data voltage, and output the display data voltage to the small-scale mobile panel.

The host can be a central process unit (CPU), a micro process unit (MPU), or an application processor (AP).

According to another aspect of the present invention, there is provided a universal serial bus (USB) display driver including: a USB receiving unit configured to serially receive an image data signal from a host via a USB interface, and to extract display data and control data from the image data signal; and a display driver configured to generate a display data voltage corresponding to the display data based on the control data, and to apply the display data voltage to a small-scale mobile panel, wherein the USB receiving unit, the display driver and the small-scale mobile panel operate using power delivered via the USB interface, and a panel size of the small-scale mobile panel is less than or equal to a panel size corresponding to a maximum speed of data transmission of the USB interface.

According to another aspect of the present invention, there is provided a small-scale mobile monitor including: a universal serial bus (USB) display driver configured to serially receive an image data signal from a host computer via a USB cable, extract display data and control data from the image data signal, and generate a display data voltage corresponding to the display data based on the control data; and a small-scale mobile panel configured to receive the display data voltage and to display an image corresponding to the image data signal, wherein a panel size of the small-scale mobile panel is less than or equal to a panel size corresponding to a maximum speed of data transmission of the USB cable, and a display operation is performed using power delivered via the USB cable.

The USB display driver can comprise: a USB receiving unit configured to extract the display data and the control data from the image data signal serially received via the USB cable; and a display driver configured to generate the display data voltage corresponding to the display data based on the control data.

The USB receiving unit can comprise: a physical layer block configured to serially receive the image data signal via the USB cable; a data separating unit configured to separate the image data signal to extract the display data and the control data; a display data output unit configured to output the display data; and a control data output unit configured to output the control data.

The display driver can comprise: a register unit configured to receive the control data and to extract format information and address information from the control data; a pixel format unit configured to format the display data to conform to the format information and to output the formatted display data; an address generation unit configured to receive the address information and to generate an address signal; a frame buffer configured to store the formatted display data in an address corresponding to the address signal; and an analog processor configured to receive the formatted display data from the frame buffer, generate the display data voltage, and output the display data voltage to the small-scale mobile panel.

According to another aspect of the present invention, there is provided a universal serial bus (USB) display system including: a host computer configured to output a main image data signal via a monitor cable, and to output first sub image data signal and second sub image data signal via a USB cable; a main display monitor configured to display a main image corresponding to the main image data signal received via the monitor cable; a USB hub configured to connect the USB cable to a first USB cable and a second USB cable; a first small-scale mobile monitor configured to display a first sub image corresponding to the first sub image data signal serially received via the first USB cable; and a second small-scale mobile monitor configured to display a second sub image corresponding to the second sub image data signal serially received via the second USB cable.

The first small-scale mobile monitor can perform a display operation by using power delivered via the first USB cable.

The first small-scale mobile monitor can comprise: a USB display driver configured to serially receive the first sub image data signal via the first USB cable, extract display data and control data from the first sub image data signal, and generate a display data voltage corresponding to the display data based on the control data; and a small-scale mobile panel configured to receive the display data voltage and to display the first sub image corresponding to the first sub image data signal.

A panel size of the small-scale mobile panel can be less than or equal to a panel size corresponding to a maximum speed of data transmission of the first USB cable.

The USB display driver can comprise: a USB receiving unit configured to extract the display data and the control data from the first sub image data signal serially received via the first USB cable; and a display driver configured to generate the display data voltage corresponding to the display data based on the control data.

The second small-scale mobile monitor can perform a display operation by using power delivered via the second USB cable.

The second small-scale mobile monitor can include: a USB display driver configured to serially receive the second sub image data signal via the second USB cable, extract display data and control data from the second sub image data signal, and generate a display data voltage corresponding to the display data based on the control data; and a small-scale mobile panel configured to receive the display data voltage and to display the second sub image corresponding to the second sub image data signal.

A panel size of the small-scale mobile panel can be less than or equal to a panel size corresponding to a maximum speed of data transmission of the second USB cable.

The USB display driver can comprise: a USB receiving unit configured to extract the display data and the control data from the second sub image data signal serially received via the second USB cable; and a display driver configured to generate the display data voltage corresponding to the display data based on the control data.

The monitor cable can be connected to a graphic card of the host computer, and the USB cable can be connected to a USB transmission unit of the host computer.

### BRIEF DESCRIPTION OF THE DRAWINGS

The above and other features and advantages of the present invention will become more apparent by describing in detail exemplary embodiments thereof with reference to the attached drawings in which: The embodiments depicted therein are provided by way of example, not by way of limitation, wherein like reference numerals refer to the same or similar elements. The drawings are not necessarily to scale, emphasis instead being placed upon illustrating aspects of the invention. In the drawings:

FIG. 1 illustrates a conventional small-scale display device having a conventional interface between a host and a display monitor thereof;

FIG. 2 is a block diagram of an embodiment of a universal serial bus (USB) display according to an aspect of the present invention;

FIG. 3A is a block diagram of an embodiment of a one-chip USB display driver;

FIG. 3B is a block diagram of a an embodiment of two-chip USB display driver;

FIG. 4 is a block diagram of another embodiment of a USB display according to another aspect of the present invention; and

FIG. 5 is a block diagram of yet another embodiment of a USB display according to another aspect of the present invention.

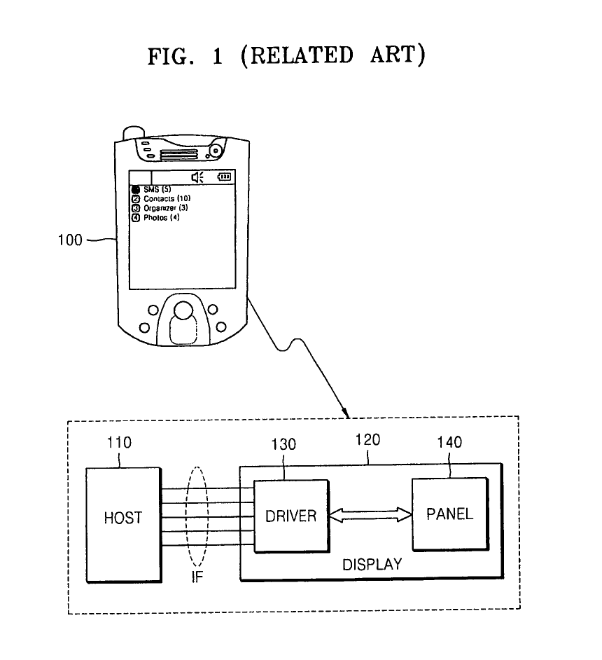

### DETAILED DESCRIPTION OF PREFERRED EMBODIMENTS

Hereinafter, aspects of the present invention will be described by explaining exemplary embodiments in accordance therewith, and with reference to the accompanying drawings. In the following description, well-known functions or constructions are not described in detail if it is determined that they would obscure the invention due to unnecessary detail.

It will be understood that, although the terms first, second, etc. are be used herein to describe various elements, these elements should not be limited by these terms. These terms are used to distinguish one element from another, but not to imply a required sequence of elements. For example, a first element can be termed a second element, and, similarly, a second element can be termed a first element, without departing from the scope of the present invention. As used herein, the term “and/or” includes any and all combinations of one or more of the associated listed items.

It will be understood that when an element is referred to as being “on” or “connected” or “coupled” to another element, it can be directly on or connected or coupled to the other element or intervening elements can be present. In contrast, when an element is referred to as being “directly on” or “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, steps, operations, elements, and/or components, but do not preclude the presence or addition of one or more other features, steps, operations, elements, components, and/or groups thereof.

Spatially relative terms, such as “beneath,” “below,” “lower,” “above,” “upper” and the like can be used to describe an element and/or feature's relationship to another element(s) and/or feature(s) as, for example, illustrated in the figures. It will be understood that the spatially relative terms are intended to encompass different orientations of the device in use and/or operation in addition to the orientation depicted in the figures. For example, if the device in the figures is turned over, elements described as “below” and/or “beneath” other elements or features would then be oriented “above” the other elements or features. The device can be otherwise oriented (e.g., rotated 90 degrees or at other orientations) and the spatially relative descriptors used herein interpreted accordingly.

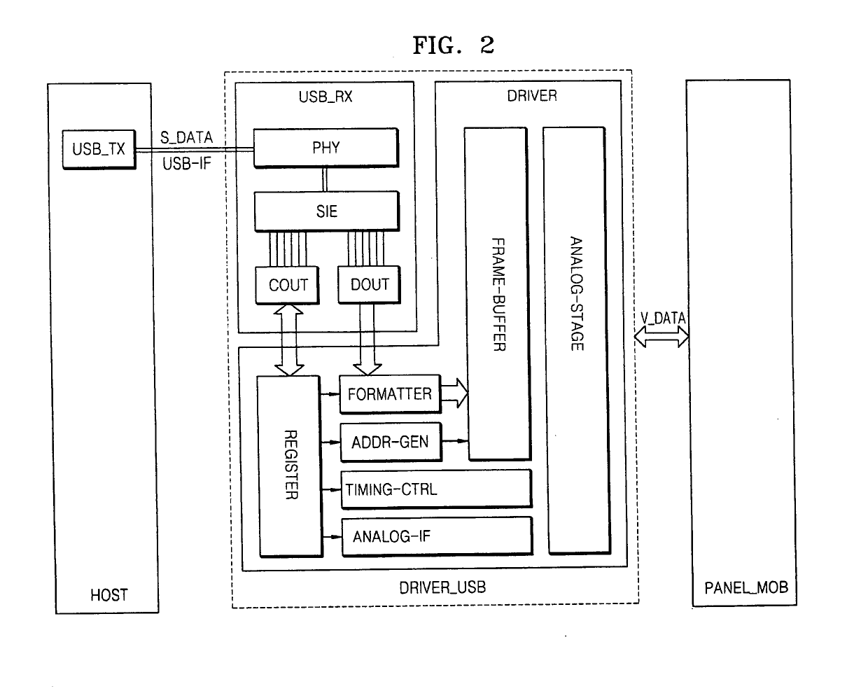

FIG. 2 is a block diagram of an embodiment of a universal serial bus (USB) display according to an aspect of the present invention. The USB display system includes a host HOST, a USB display driver DRIVER_USB, and a small-scale mobile panel PANEL_MOB. Referring to FIG. 2, the host HOST includes a USB transmission unit USB_TX, and the USB display driver DRIVER_USB includes a USB receiving unit USB_RX and a display driver DRIVER. The USB receiving unit USB_RX includes a physical layer block PHY, a serial interface engine SIE, a control data output unit COUT, and a display data output unit DOUT. The display driver DRIVER includes a register unit REGISTER, a pixel format unit FORMATTER, an address generation unit ADDR-GEN, a timing controller TIMING-CTRL, an analog interface unit ANALOG-IF, a frame buffer FRAME-BUFFER, and an analog processor ANALOG-STAGE.

The host HOST outputs image data signal S_DATA in series by using the USB transmission unit USB_TX. The image data signal S_DATA contains display data and control data. Here, the display data correspond to an image that is ultimately displayed on small-scale mobile panel PANEL_MOB. The control data contains format information, address information, timing information, and analog interface information regarding image display.

The host HOST illustrated in FIG. 2 can be a central process unit (CPU), a micro-process unit (MPU), or an application processor (AP), as examples. However, the host HOST of the USB display system is not limited to the CPU, the MPU or the AP.

The image data signal S_DATA is transmitted in series from the USB transmission unit USB_TX to the USB receiving unit USB_RX via a USB interface USB-IF. According to the USB 2.0 specifications, the maximum speed of data transmission of the USB interface USB-IF is 480 mega bit per second (Mbps). According to aspects of the present invention, the USB transmission unit USB_TX, the USB interface USB-IF, and the USB receiving unit USB_RX are used to transmit the image data signal S_DATA from the host HOST to the USB display driver DRIVER_USB, thereby securing compatibility. Accordingly, a manufacturing company of the USB display driver DRIVER_USB will not be under any restrictions except that its products must conform to the industry accepted USB interface specifications. For this reason, it is possible to reduce a period of time and manufacturing costs required to develop products using this type of technology. The USB display driver DRIVER_USB is considered a compatible display driver since it conforms to the industry accepted USB interface specifications.

The USB receiving unit USB_RX extracts the display data and the control data from the image data signal S_DATA received in series via the USB interface USB-IF.

The physical layer block PHY receives the image data signal S_DATA in series via the USB interface USB-IF. The serial interface engine SIE separates the image data signal S_DATA, which is received in series, and then extracts the display data and the control data therefrom. The display data extracted by the serial interface engine SIE is supplied to the display driver DRIVER via the display data output unit DOUT. The control data extracted by the serial interface engine SIE is supplied to the display driver DRIVER via the control data output unit COUT. Referring to FIG. 2, the display data output unit DOUT receives the display data in parallel from the serial interface engine SIE, and then outputs the display data in parallel to the pixel format unit FORMATTER of the display driver DRIVER. The control data output unit COUT receives the control data in parallel from the serial interface engine SIE, and then outputs the control data in parallel to the register unit REGISTER of the display driver DRIVER.

The display driver DRIVER generates a display data voltage V_DATA corresponding to the display data based on the control data.

The register unit REGISTER receives the control data, and extracts format information, address information, timing information, and analog interface information from the control data. Referring to FIG. 2, the pixel format unit FORMATTER receives the display data from the display data output unit DOUT, and the format information from the register unit REGISTER. The pixel format unit FORMATTER formats the display data to correspond to the format information, and outputs the formatted display data. The address generation unit ADDR-GEN receives the address information from the register unit REGISTER and generates an address signal. The frame buffer FRAME-BUFFER stores the formatted display data received from the pixel format unit FORMATTER in an address corresponding to an address signal. The timing controller TIMING-CTRL controls the timing of the display driver DRIVER based on the timing information received from the register unit REGISTER. The analog interface unit ANALOG-IF controls an analog interface of the display driver DRIVER according to the analog interface information received from the register unit REGISTER. The analog processor ANALOG-STAGE receives the formatted display data from the frame buffer FRAME-BUFFER and generates the display data voltage V_DATA. The display data voltage V_DATA generated by the analog processor ANALOG-STAGE is supplied to the small-scale mobile panel PANEL_MOB.

The small-scale mobile panel PANEL_MOB receives the display data voltage V_DATA from the display driver DRIVER and displays an image corresponding to the image data signal S_DATA. The small-scale mobile panel PANEL_MOB illustrated in FIG. 2 can be a display panel included in a handheld-phone (or mobile phone), a portable multimedia player (PMP), a personal digital assistant (PDA), a navigation device, or a digital camera, but it is not limited thereto.

The panel size of the small-scale mobile panel PANEL_MOB is limited by the maximum speed of data transmission supported by the USB interface USB-IF. In detail, the panel size of the small-scale mobile panel PANEL_MOB is less than or equal to a panel size corresponding to an image that can be displayed when the USB interface USB-IF transmits the image data signal S_DATA at the maximum speed of data transmission.

More specifically, the greater the panel size of a display panel, the more display data required to display a one-frame image. If more display data is required, image data signals must be transmitted from a host to a display driver at a higher data transmission speed. That is, the greater the panel size of the display panel, the faster the speed at which the image data signal must be transmitted. However, the speed of data transmission of a USB interface is limited to a predetermined range of speed, and thus, it is difficult to expect that the display driver will normally operate when a speed of data transmission required exceeds the maximum speed of data transmission of the USB interface since the panel size of the display panel is relatively large.

For example, if the maximum speed of data transmission of a USB interface is 480 Mbps according to the USB 2.0 specifications, the USB interface of the USB 2.0 specifications cannot support a normal display operation with respect to a display panel that desires to receive display data of more than 480 Megabits per second. Thus, in accordance with aspects of the present invention, the panel size of the small-scale mobile panel PANEL_MOB of the USB display system is set to be less than or equal to a panel size corresponding to the maximum speed of data transmission of the USB interface USB-IF.

In the USB display system of this embodiment, the USB receiving unit USB_RX, the display driver DRIVER, and the small-scale mobile panel PANEL_MOB can operate using power delivered via the USB interface USB-IF. That is, the USB display driver DRIVER_USB and the small-scale mobile panel PANEL_MOB can perform a display operation by using power delivered via the USB interface USB-IF, not via an additional power source device. As will be appreciated by those skilled in the art, given the benefit of this disclosure, the USB display driver DRIVER_USB and the small-scale mobile panel PANEL_MOB have low-power consuming characteristics if considering that the small-scale mobile panel PANEL_MOB employed in the USB display system according to the present embodiment is not only a small-scale panel, but also a mobile panel suitable for a mobile device. The USB display driver DRIVER_USB and the small-scale mobile panel PANEL_MOB can perform a display operation by using only power delivered by USB interface USB-IF—without depending on an additional power source device, thereby reducing power consumption as compared to prior systems.

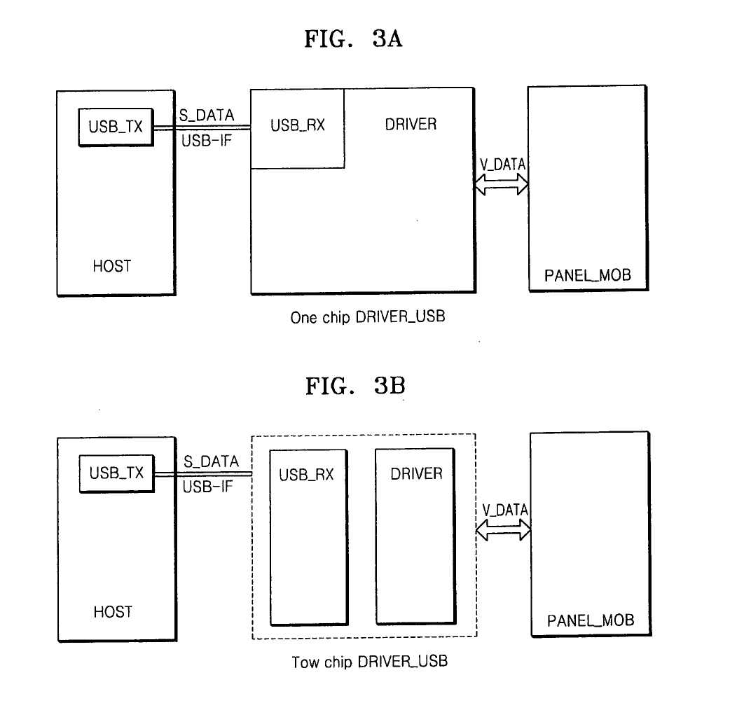

FIG. 3A illustrates an embodiment of a one-chip USB display driver DRIVER_USB according to an aspect of the present invention. FIG. 3B illustrates an embodiment of a two-chip USB display driver Two chip DRIVER_USB according to another aspect of the present invention.

As illustrated in FIGS. 3A and 3B, a USB display driver DRIVER_USB according to aspects of the present invention can be realized as a one-chip USB display driver or a two-chip USB display driver. Referring to FIG. 3A, if the USB display driver DRIVER_USB is realized using one chip, a USB receiving unit USB_RX and a display driver DRIVER are integrated on the one chip. Referring to FIG. 3B, if the USB display driver DRIVER_USB is realized using two chips, a USB receiving unit USB_RX is integrated on one of the two chips that is different from a chip on which a display driver DRIVER is integrated. If the USB display driver DRIVER_USB is realized using two chips, the chip on which the USB receiving unit USB_RX is integrated functions as a bridge chip that connects a host HOST to a display driver DRIVER.

The USB receiving unit USB_RX of the USB display driver DRIVER_USB illustrated in FIG. 3A or 3B receives image data signal S_DATA in series from a USB transmission unit USB_TX of the host HOST via a USB interface USB-IF and then extracts display data and control data from the image data signal S_DATA. A display driver DRIVER of the USB display driver DRIVER_USB illustrated in FIG. 3A or FIG. 3B generates a display data voltage V_DATA corresponding to display data based on the control data, and applies the display data voltage V_DATA to a small-scale mobile panel PANEL_MOB. As described above, the USB receiving unit USB_RX, the display driver DRIVER, and the small-scale mobile panel PANEL_MOB can perform a display operation by using power delivered via the USB interface USB-IF, and the panel size of the small-scale mobile panel PANEL_MOB is less than or equal to a panel size corresponding to the maximum speed of data transmission of the USB interface USB-IF.

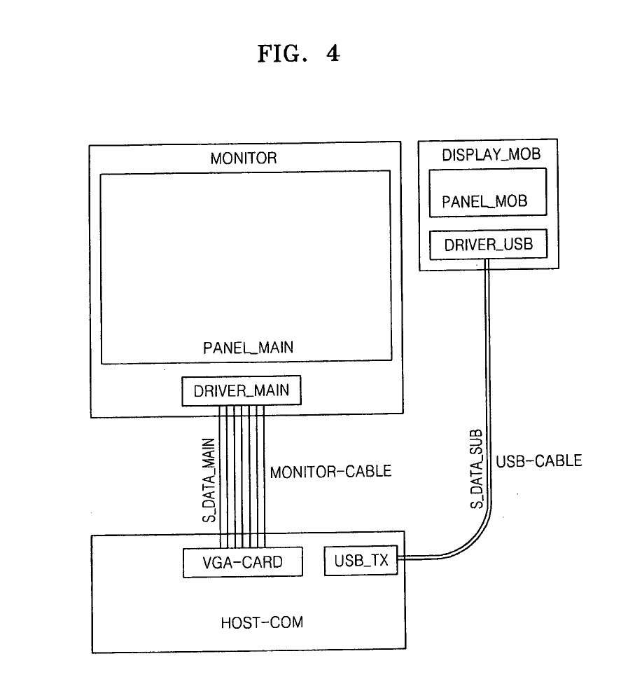

FIG. 4 is a block diagram of an embodiment of a USB display system according to another aspect of the present invention. FIG. 4 illustrates a host computer HOST-COM that includes a graphic card VGA-CARD and a USB transmission unit USB_TX, a main display monitor MONITOR that includes a main display panel PANEL_MAIN and a main display driver DRIVER_MAIN, and a small-scale mobile monitor DISPLAY_MOB that includes a small-scale mobile panel PANEL_MOB and a USB display driver DRIVER_USB. The graphic card VGA-CARD of the host computer HOST-COM transmits a main image data signal S_DATA_MAIN to the main display driver DRIVER_MAIN of the main display monitor MONITOR via a monitor cable MONITOR-CABLE. The USB transmission unit USB_TX of the host computer HOST-COM transmits sub image data signal S_DATA_SUB to the USB display driver DRIVER_USB of the small-scale mobile monitor DISPLAY_MOB via the USB cable USB-CABLE.

In the USB display system illustrated in FIG. 4, the small-scale mobile monitor DISPLAY_MOB can function as a sub monitor. That is, while the main display monitor MONITOR receives the main image data signal S_DATA_MAIN from the host computer HOST-COM via the monitor cable MONITOR-CABLE and then displays a main image corresponding to the main image data signal S_DATA_MAIN, the small-scale mobile monitor DISPLAY_MOB receives the sub image data signal S_DATA_SUB in series from the host computer HOST-COM via the USB cable USB-CABLE and then displays a sub image corresponding to the sub image data signal S_DATA_SUB. As described above, the small-scale mobile monitor DISPLAY_MOB illustrated in FIG. 4 can perform a display operation by using only power delivered via the USB cable USB-CABLE without depending on an additional power source device.

The USB transmission unit USB_TX of the host computer HOST-COM illustrated in FIG. 4 corresponds to the USB transmission unit USB_TX of the host HOST illustrated in any one or more of FIGS. 2, 3A and 3B.

The USB display driver DRIVER_USB of the small-scale mobile monitor DISPLAY_MOB illustrated in FIG. 4 can correspond to the USB display driver DRIVER_USB illustrated in any one or more of FIGS. 2, 3A and 3B. The USB display driver DRIVER_USB of FIG. 4 receives the sub image data signal S_DATA_SUB in series from the host computer HOST-COM via the USB cable USB-CABLE, extracts display data and control data from the sub image data signal S_DATA_SUB, and then generates a display data voltage corresponding to the display data based on the control data.

Although not shown, the USB display driver DRIVER_USB of FIG. 4 can include a USB receiving unit (corresponding to the USB receiving unit USB_RX of FIG. 2) that extracts the display data and the control data from the image data signal S_DATA_SUB received in series from via the USB cable USB-CABLE, and a display driver (corresponding to the USB display driver DRIVER of FIG. 2) that generates the display data voltage corresponding to the display data based on the control data.

The USB receiving unit (corresponding to the USB receiving unit USB_RX of FIG. 2) of the USB display driver DRIVER_USB illustrated in FIG. 4 can include a physical layer block PHY that receives the image data signal S_DATA_SUB in series via the USB cable USB-CABLE, a serial interface engine SIE that extracts the display data and the control data by separating the sub image data signal S_DATA_SUB, a display data output unit DOUT that outputs the extracted display data, and a control data output unit COUT that outputs the extracted control data.

The display driver (corresponding to the USB display driver DRIVER of FIG. 2) of the USB display driver DRIVER_USB of FIG. 4 can include a register unit REGISTER that receives the control data and extracts format information and address information from the control data, a pixel format unit FORMATTER that formats the display data received from the display data output unit DOUT so that the display data can conform to the format information received from the register unit REGISTER and then outputs the formatted display data, an address generation unit ADDR-GEN that receives the address information from the register unit REGISTER and generates an address signal, a frame buffer FRAME-BUFFER that stores the formatted display data in an address corresponding to the address signal, and an analog processor ANALOG-STAGE that receives the formatted display data from the frame buffer FRAME-BUFFER, generates the display data voltage, and then supplies the display data voltage to the small-scale mobile panel PANEL_MOB.

The small-scale mobile panel PANEL_MOB of the small-scale mobile monitor DISPLAY_MOB illustrated in FIG. 4 can correspond to the small-scale mobile panel PANEL_MOB illustrated in any one or more of FIG. 2, 3A or 3B. Referring to FIG. 4, if the display driver (corresponding to the USB display driver DRIVER of FIG. 2) of the USB display driver DRIVER_USB applies the display data voltage to the small-scale mobile panel PANEL_MOB, the small-scale mobile panel PANEL_MOB displays a sub image corresponding to the sub image data signal S_DATA_SUB. As described above, the panel size of the small-scale mobile panel PANEL_MOB is less than or equal to a panel size corresponding to the maximum speed of data transmission of the USB cable USB-CABLE.

The small-scale mobile monitor DISPLAY_MOB can be attached to a side surface of the main display monitor MONITOR in order to function as a sub monitor but the present invention is not limited thereto. For example, the small-scale mobile monitor DISPLAY_MOB according to aspects of the present invention can be detached from the main display monitor MONITOR in some cases. The small-scale mobile monitor DISPLAY_MOB is not only a small-scale monitor, but also a mobile monitor. A user can carry the small-scale mobile monitor DISPLAY_MOB with himself or herself while disconnecting the small-scale mobile monitor DISPLAY_MOB from the USB cable USB-CABLE.

A built-in host can be installed into the small-scale mobile monitor DISPLAY_MOB. In this case, the small-scale mobile monitor DISPLAY_MOB can operate in various operation modes. For example, in a self-operation mode, the small-scale mobile monitor DISPLAY_MOB is controlled by the built-in host, and in a display operation mode, the small-scale mobile monitor DISPLAY_MOB receives a data signal from the host computer HOST-COM. Also, in a transmission operation mode, the small-scale mobile monitor DISPLAY_MOB can transmit a data signal to the host computer HOST-COM via the USB cable USB-CABLE.

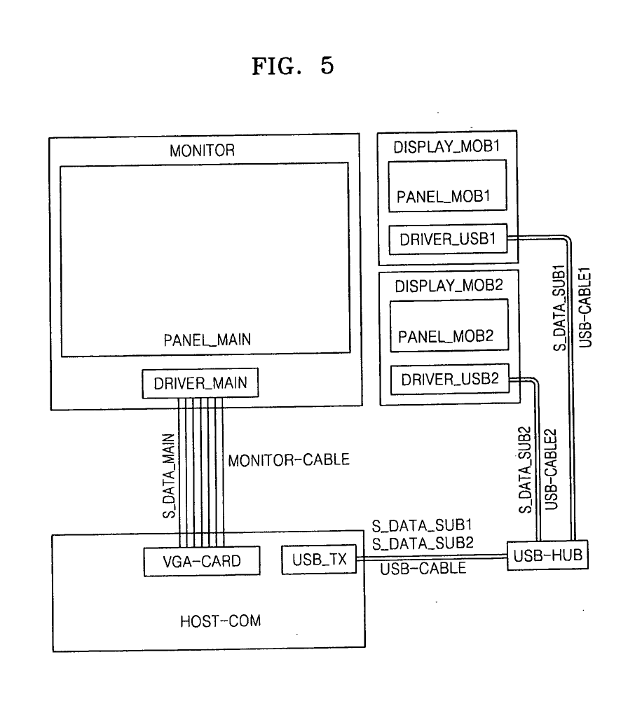

FIG. 5 is a block diagram of another embodiment of a USB display system according to another aspect of the present invention. FIG. 5 illustrates a host computer HOST-COM that includes a graphic card VGA-CARD and a USB transmission unit USB_TX, a main display monitor MONITOR that includes a main display panel PANEL_MAIN and a main display driver DRIVER_MAIN, a USB-HUB that connects a USB cable USB-CABLE to a first USB cable USB-CABLE1 and a second USB cable USB-CABLE2, a first small-scale mobile monitor DISPLAY_MOB1 that includes a first small-scale mobile panel PANEL_MOB1 and a first USB display driver DRIVER_USB1, and a second small-scale mobile monitor DISPLAY_MOB2 that includes a second small-scale mobile panel PANEL_MOB2 and a second USB display driver DRIVER_USB2.

Although FIG. 5 illustrates a USB display system with the two small-scale mobile monitors DISPLAY_MOB1 and DISPLAY_MOB2, the present invention is not limited thereto. That is, the USB display system according to aspects of the present invention uses the USB hub USB-HUB and, thus, can include three or more small-scale mobile monitors.

The graphic card VGA-CARD of the host computer HOST-COM transmits a main image data signal S_DATA_MAIN to the main display driver DRIVER_MAIN of the main display monitor MONITOR via a monitor cable MONITOR-CABLE. A main image corresponding to the main image data signal S_DATA_MAIN is displayed on the main display panel PANEL_MAIN of the main display monitor MONITOR. A USB transmission unit USB_TX of the host computer HOST-COM transmits first sub image data signal S_DATA_SUB1 to the first USB display driver DRIVER_USB1 of the first small-scale mobile monitor DISPLAY_MOB1 via the USB cable USB-CABLE, the USB hub USB-HUB, and the first USB cable USB-CABLE1. A first sub image corresponding to the first sub image data signal S_DATA_SUB1 is displayed on the first small-scale mobile panel PANEL_MOB1 of the first small-scale mobile monitor DISPLAY_MOB1. Also, the USB transmission unit USB_TX of the host computer HOST-COM transmits second sub image data signal S_DATA_SUB2 to the second USB display driver DRIVER_USB2 of the second small-scale mobile monitor DISPLAY_MOB2 via the USB cable USB-CABLE, the USB hub USB-HUB, and the second USB cable USB-CABLE2. Then, a second sub image corresponding to the second sub image data signal S_DATA_SUB2 is displayed on the second small-scale mobile panel PANEL_MOB2 of the second small-scale mobile monitor DISPLAY_MOB2. In the USB display system illustrated in FIG. 5, the first and second small-scale mobile monitors DISPLAY_MOB1 and DISPLAY_MOB2 function as sub-monitors.

As described above, referring to FIG. 5, the first small-scale mobile monitor DISPLAY_MOB1 can perform a display operation using only power delivered via the first USB cable USB-CABLE1 and the second small-scale mobile monitor DISPLAY_MOB2 can perform a display operation using only power delivered via the second USB cable USB-CABLE2, without depending on an additional power source device. The panel size of the small-scale mobile panel PANEL_MOB1 of the first small-scale mobile monitor DISPLAY_MOB1 is less than or equal to a panel size corresponding to the maximum speed of data transmission of the first USB cable USB-CABLE1. The panel size of the small-scale mobile panel PANEL_MOB2 of the second small-scale mobile monitor DISPLAY_MOB2 is less than or equal to a panel size corresponding to the maximum speed of data transmission of the second USB cable USB-CABLE2. That is, the panel sizes of the first and second small-scale mobile panels PANEL_MOB1 and PANEL_MOB2 are limited by the maximum speeds of data transmission supported by the USB cables USB-CABLE, USB-CABLE1, and USB-CABLE2.

Referring to FIG. 5, the first USB display driver DRIVER_USB1 of the first small-scale mobile monitor DISPLAY_MOB1 receives the first sub image data signal S_DATA_SUB1 in series via the first USB cable USB-CABLE1, extracts display data and control data from the first sub image data signal S_DATA_SUB1, and then generates a display data voltage corresponding to the display data based on the control data. To this end, although not shown, the first USB display driver DRIVER_USB1 can include a USB receiving unit (corresponding to the USB receiving unit USB_RX of FIG. 2) that extracts the display data and the control data from the first sub image data signal S_DATA_SUB1 received in series via the first USB cable USB-CABLE1, and a display driver (corresponding to the USB display driver DRIVER of FIG. 2) that generates a display data voltage corresponding to the display data based on the control data. The display data voltage generated by the USB display driver DRIVER_USB1 is applied to the first small-scale mobile panel PANEL_MOB1, and then, the first sub image corresponding to the first sub image data signal S_DATA_SUB1 is displayed on the small-scale mobile panel PANEL_MOB1.

Referring to FIG. 5, the second USB display driver DRIVER_USB2 of the second small-scale mobile monitor DISPLAY_MOB2 receives the second sub image data signal S_DATA_SUB2 in series via the second USB cable USB-CABLE2, extracts display data and control data from the second sub image data signal S_DATA_SUB2, and then generates a display data voltage corresponding to the display data based on the control data. To this end, although not shown, the USB display driver DRIVER_USB2 can include a USB receiving unit (corresponding to the USB receiving unit USB_RX of FIG. 2) that extracts the display data and the control data from the second sub image data signal S_DATA_SUB2 received in series from the second USB cable USB-CABLE2, and a display driver (corresponding to the USB display driver DRIVER of FIG. 2) that generates the display data voltage corresponding to the display data based on the control data. The display data voltage generated by the USB display driver DRIVER_USB2 is applied to the second small-scale mobile panel PANEL_MOB2, and then the second sub image corresponding to the second sub image data signal S_DATA_SUB2 is displayed on the small-scale mobile panel PANEL_MOB2.

According to the present invention, it is possible to provide a compatible USB display system. There are no restrictions to development of a small-scale mobile monitor except conforming it to the USB interface specifications, without respect to a manufacturing company of or the specifications of a small-scale mobile monitor, thereby reducing a period of time and costs of developing products.

While the foregoing has described what are considered to be the best mode and/or other preferred embodiments, it is understood that various modifications can be made therein and that the invention or inventions may be implemented in various forms and embodiments, and that they may be applied in numerous applications, only some of which have been described herein. It is intended by the following claims to claim that which is literally described and all equivalents thereto, including all modifications and variations that fall within the scope of each claim.

What is claimed is:

1. A universal serial bus (USB) display system comprising:
a host having a USB transmission unit configured to serially output an image data signal containing display data and control data;
a USB receiving unit configured to extract the display data and the control data from the image data signal serially received via a USB interface;
a display driver configured to generate a display data voltage corresponding to the display data based on the control data; and
a small-scale mobile panel configured to receive the display data voltage and to display an image corresponding to the image data signal.

2. The system of claim 1, wherein the USB receiving unit, the display driver, and the small-scale mobile panel operate using power delivered via the USB interface.

3. The system of claim 1, wherein a panel size of the small-scale mobile panel is limited by a maximum speed of data transmission supported by the USB interface.

4. The system of claim 3, wherein the panel size of the small-scale mobile panel is less than or equal to a panel size corresponding to a maximum size of an image that is to be displayed when the USB interface transmits the image data signal at the maximum speed of data transmission.

5. The system of claim 3, wherein the small-scale mobile panel is a display panel included in a handheld-phone, a portable multimedia player (PMP), a personal digital assistant (PDA), a navigation device, or a digital camera.

6. The system of claim 1, wherein the USB receiving unit and the display driver are integrated on one chip.

7. The system of claim 1, wherein the USB receiving unit is integrated on a chip different from a chip on which the display driver is integrated.

8. The system of claim 1, wherein the USB receiving unit comprises:
a physical layer block configured to serially receive the image data signal via the USB interface;
a data separating unit configured to separate the image data signal and to extract the display data and the control data;
a display data output unit configured to output the display data; and
a control data output unit configured to output the control data.

9. The system of claim 8, wherein the display data output unit is configured to receive the display data in parallel from the data separating unit, and to output the display data in parallel to the display driver.

10. The system of claim 8, wherein the control data output unit is configured to receive the control data in parallel from the data separating unit, and to output the control data in parallel to the display driver.

11. The system of claim 1, wherein the display driver comprises:
a register unit configured to receive the control data and to extract format information and address information from the control data;
a pixel format unit configured to format the display data to conform to the format information and then to output the formatted display data;
an address generation unit configured to receive the address information and to generate an address signal; and
a frame buffer configured to store the formatted display data in an address corresponding to the address signal.

12. The system of claim 11, wherein the control data further comprises timing information and analog interface information.

13. The system of claim 12, wherein the display driver further comprises:
a timing controller configured to control timing of the display driver to conform to the timing information; and
an analog interface unit configured to control an analog interface of the display driver to conform to the analog interface information.

14. The system of claim 11, wherein the display driver further comprises an analog processor configured to receive the formatted display data from the frame buffer, generate the display data voltage, and output the display data voltage to the small-scale mobile panel.

15. The system of claim 1, wherein the host is a central process unit (CPU), a micro process unit (MPU), or an application processor (AP).

16. A universal serial bus (USB) display driver comprising:
a USB receiving unit configured to serially receive an image data signal from a host via a USB interface, and to extract display data and control data from the image data signal; and
a display driver configured to generate a display data voltage corresponding to the display data based on the control data, and to apply the display data voltage to a small-scale mobile panel,
wherein the USB receiving unit, the display driver and the small-scale mobile panel operate using power delivered via the USB interface, and
a panel size of the small-scale mobile panel is less than or equal to a panel size corresponding to a maximum speed of data transmission of the USB interface.

17. A small-scale mobile monitor comprising:
a universal serial bus (USB) display driver configured to serially receive an image data signal from a host computer via a USB cable, extract display data and control data from the image data signal, and generate a display data voltage corresponding to the display data based on the control data; and
a small-scale mobile panel configured to receive the display data voltage and to display an image corresponding to the image data signal,
wherein a panel size of the small-scale mobile panel is less than or equal to a panel size corresponding to a maximum speed of data transmission of the USB cable, and a display operation is performed using power delivered via the USB cable.

18. The monitor of claim 17, wherein the USB display driver comprises:
a USB receiving unit configured to extract the display data and the control data from the image data signal serially received via the USB cable; and
a display driver configured to generate the display data voltage corresponding to the display data based on the control data.

19. The monitor of claim 18, wherein the USB receiving unit comprises:
a physical layer block configured to serially receive the image data signal via the USB cable;
a data separating unit configured to separate the image data signal to extract the display data and the control data;
a display data output unit configured to output the display data; and
a control data output unit configured to output the control data.

20. The monitor of claim 18, wherein the display driver comprises:
a register unit configured to receive the control data and to extract format information and address information from the control data;
a pixel format unit configured to format the display data to conform to the format information and to output the formatted display data;
an address generation unit configured to receive the address information and to generate an address signal;
a frame buffer configured to store the formatted display data in an address corresponding to the address signal; and
an analog processor configured to receive the formatted display data from the frame buffer, generate the display data voltage, and output the display data voltage to the small-scale mobile panel.

21. A universal serial bus (USB) display system comprising:
a host computer configured to output a main image data signal via a monitor cable, and to output first sub image data signal and second sub image data signal via a USB cable;
a main display monitor configured to display a main image corresponding to the main image data signal received via the monitor cable;
a USB hub configured to connect the USB cable to a first USB cable and a second USB cable;
a first small-scale mobile monitor configured to display a first sub image corresponding to the first sub image data signal serially received via the first USB cable; and
a second small-scale mobile monitor configured to display a second sub image corresponding to the second sub image data signal serially received via the second USB cable.

22. The system of claim 21, wherein the first small-scale mobile monitor performs a display operation using power delivered via the first USB cable.

23. The system of claim 22, wherein the first small-scale mobile monitor comprises:
a USB display driver configured to serially receive the first sub image data signal via the first USB cable, extract display data and control data from the first sub image data signal, and generate a display data voltage corresponding to the display data based on the control data; and
a small-scale mobile panel configured to receive the display data voltage and to display the first sub image corresponding to the first sub image data signal.

24. The system of claim 23, wherein a panel size of the small-scale mobile panel is less than or equal to a panel size corresponding to a maximum speed of data transmission of the first USB cable.

25. The system of claim 23, wherein the USB display driver comprises:
a USB receiving unit configured to extract the display data and the control data from the first sub image data signal serially received via the first USB cable; and
a display driver configured to generate the display data voltage corresponding to the display data based on the control data.

26. The system of claim 21, wherein the second small-scale mobile monitor performs a display operation using power delivered via the second USB cable.

27. The system of claim 26, wherein the second small-scale mobile monitor comprises:
a USB display driver configured to serially receive the second sub image data signal via the second USB cable, extract display data and control data from the second sub image data signal, and generate a display data voltage corresponding to the display data based on the control data; and
a small-scale mobile panel configured to receive the display data voltage and to display the second sub image corresponding to the second sub image data signal.

28. The system of claim 27, wherein a panel size of the small-scale mobile panel is less than or equal to a panel size corresponding to a maximum speed of data transmission of the second USB cable.

29. The system of claim 27, wherein the USB display driver comprises:
a USB receiving unit configured to extract the display data and the control data from the second sub image data signal serially received via the second USB cable; and
a display driver configured to generate the display data voltage corresponding to the display data based on the control data.

30. The system of claim 21, wherein the monitor cable is connected to a graphic card of the host computer, and the USB cable is connected to a USB transmission unit of the host computer.
